(19) United States
(12) Patent Application Publication
(10) Pub. No.: US 2018/0071755 A1
(43) Pub. Date: Mar. 15, 2018

(54) SWIRL POT SHOWER HEAD ENGINE

(71) Applicant: Spectrum Brands, Inc., Middleton, WI (US)

(72) Inventor: Oscar Romero, Lake Forest, CA (US)

(21) Appl. No.: 15/703,566

(22) Filed: Sep. 13, 2017

Related U.S. Application Data
(60) Provisional application No. 62/393,735, filed on Sep. 13, 2016.

(51) Int. Cl. B05B 1/18; B05B 1/34

(52) U.S. Cl. CPC B05B 1/185; E03C 1/0408; B05B 1/341

(57) ABSTRACT

A showerhead engine internally swirls water within a swirling chamber. Multiple swirling chambers may be used, each separated from one another. The water is swirled with angled through holes in a mid plate. As the water passes through the angled holes it is projected out at an angle. The water then contacts the swirling chamber wall and continues to follow the curvature of the wall. The curved wall paired with the angled entry causes the water to continue to swirl within the swirling chamber. The water is released out of the swirling chamber through slots, which allow the water to retain the angular velocity at a discharge angle.

### CROSS REFERENCE TO EARLIER APPLICATION

This application claims priority to U.S. Provisional Application Ser. No. 62/393,735 filed on Sep. 13, 2016, the entire contents of which are hereby expressly incorporated herein by reference.

### TECHNICAL FIELD

The invention relates to showerhead engine devices. More particularly, the invention relates to generating flow patterns and movement of water exiting the shower engine without the use of nozzle jets or moving parts.

### BACKGROUND OF THE INVENTION

Showerheads are traditionally used to deliver water from a potable water source such as a municipal supply or a well into a bathroom shower. Many different kinds of showerheads exist to meet a wide range of needs. Some showerheads deliver a high pressure stream which is achieved my restricting the flow rate, thus increasing the pressure. Other showerheads increase the volume of water delivered, which in turn lowers the pressure of the delivered stream.

A common hurdle for any showerhead design is that state and federal laws in the United States limit the amount of water a showerhead can deliver. In order to be universally sold, a showerhead typically has to deliver no more than 2.5 gallons of water per minute. Additional limitations on water flow are also expected in the near future. As the supply of potable water pressure is typically fixed and not variable, showerhead designs are limited to the types of patterns and user experiences available to meet these strict requirements.

One known solution has been to provide the showerhead with an “engine” that manipulates the water delivery. Typical engines include turbines or nozzles that deliver a unique water delivery pattern not commonly available with a traditional showerhead. An example of a unique delivery device include turbines within the showerhead that produce swirling patterns as the water exits the showerhead.

A known issue with these types of showerheads is that as the number of parts added to a showerhead increases, the associated costs increase as well. Additionally, moving parts such as turbines introduce potential sources of failures and a level of fragility to the showerhead. Lastly, common impurities in potable water such as minerals can lead to scaling, which over time can clog the turbine or otherwise affect the performance.

What is therefore needed is a showerhead engine that produces a unique shower experience while conforming to the traditional water flow rate deliver requirements. What is also needed is a showerhead engine that produces movement of the water without the use of moving parts. What is also needed is a showerhead engine that produces a unique water flow experience in a cost effective manner.

### SUMMARY AND OBJECT OF THE INVENTION

A shower head engine includes a back plate with an opening in fluid communication with a supply of water. A mid plate spaced apart from the back plate forms a collection chamber between the back plate and the mid plate. A first set of orifices in the mid plate at a first diameter along with a second set of orifices in the mid plate at a second diameter greater than the first diameter allow water to pass through the mid plate and into a first and second swirl chamber.

The first and second swirl chambers are formed by a front plate spaced apart from the mid plate. A separation wall extending from the mid plate separates the first swirl chamber from the second swirl chamber. A first set of holes in the front plate that are in fluid communication with the first swirl chamber and a second set of holes in the front plate in fluid communication with the second swirl chamber spray the water from the respective first and second swirl chambers.

The first set of orifices in the mid plate are formed at an angle other than normal to a front side of the mid plate such that as water passes through the first set of orifices it exits the front side and enters the first swirl chamber with an angular velocity thus generating a swirling motion of the water within the first swirl chamber.

Similarly, the second set of orifices in the mid plate are formed at an angle other than normal to a front side of the mid plate such that as water passes through the second set of orifices it exits the front side and enters the second swirl chamber with an angular velocity thus generating a swirling motion of the water within the second swirl chamber.

The angular velocity of the water in first swirl chamber is in a first rotational direction (e.g., clockwise) and the angular velocity of the water in the second swirl chamber is in a second rotational direction opposite the first rotational direction (e.g., counter clockwise) such that when the water exits the respective holes in the front plate, it exits at opposing angles producing a grid like affect. The first and second set of holes in the front plate are elongated slots that are normal to the face surface which allows the angular velocity of the water within the respective swirl chambers to force the water out of the elongated slots while retaining the angular momentum and produce angled streams of water.

### BRIEF DESCRIPTION OF THE DRAWINGS

The present disclosure will be described hereafter with reference to the attached drawings which are given as non-limiting examples only, in which:

FIG. 1 is a side perspective view of a showerhead engine in use and spraying water in a lattice pattern according to an embodiment of the invention;

FIG. 2 is an exploded view of the showerhead engine of FIG. 1; and

FIG. 3 is a cross sectional view of the showerhead engine of FIG. 1.

Corresponding reference characters indicate corresponding parts throughout the several views. The exemplifications set out herein illustrate an embodiment of the invention, and such exemplifications are not to be construed as limiting the scope of the invention in any manner.

### DETAILED DESCRIPTION

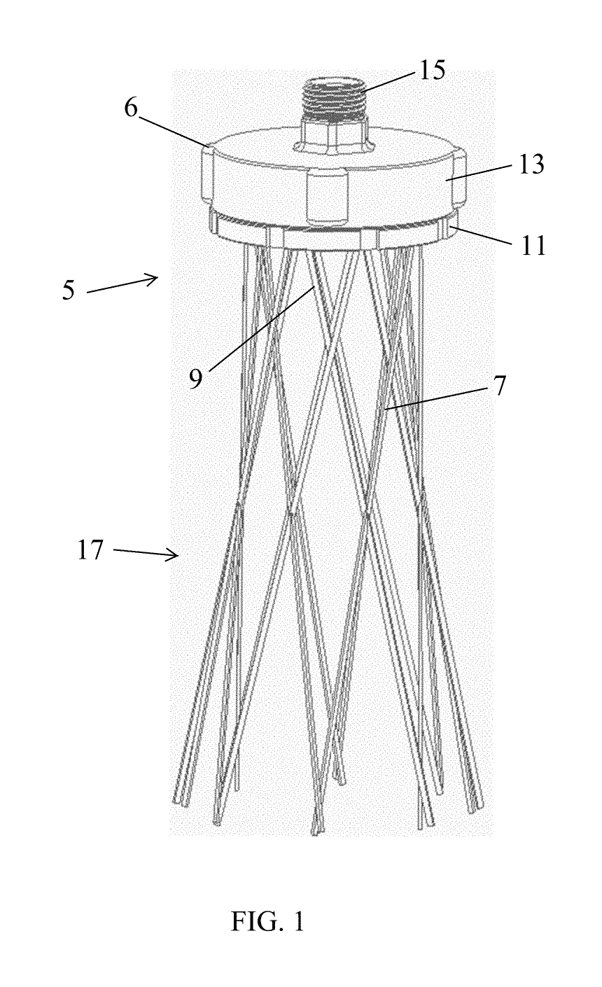

FIG. 1 shows a perspective view of the showerhead engine 5 according to an embodiment of the invention. The showerhead engine 5 may be implemented into a variety of showerheads. In this example, the showerhead engine 5 itself forms the showerhead 6. It is envisioned that the showerhead engine 5 may be fitting within any other showerhead to give it a different appearance.

The showerhead engine 5 produces a spray pattern 17 that is formed by a plurality of sets of water streams. In the embodiment shown, a first set of streams 7 exit the front plate 11 of the showerhead engine 5 at one angle, while a second set of streams 9 exit the front plate 11 at a different angle. The exact degree of each respective angle may be changed without departing from the nature of the invention. Preferably, the showerhead engine produces multiple streams of water at unique angles to produce a lattice or grid-like appearance.

The angled water streams are not produced by conventional nozzles which are typically angled. Instead, the showerhead engine 5 generates a swirling motion for the water between the back plate 13 and the front plate 11. The water may be introduced to the showerhead engine 5 through a threaded collar 15 as shown, but any other known fastening mechanism may be used to provide water to the showerhead engine 5.

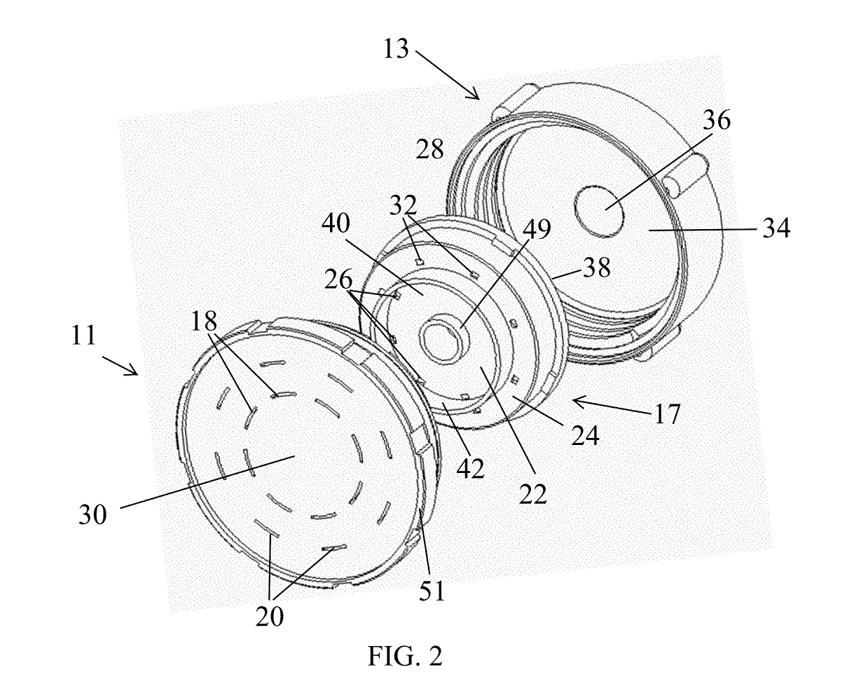

Looking now at FIG. 2, the showerhead engine 5 is in exploded form showing the inner workings within the back plate 13 and the front plate 11. As water enters an opening 36 in the back plate 13, it is collected within a collection chamber 34. A mid plate 17 seals against the back plate 13 by a support flange 28, thus preventing the water from bypassing the mid plate 17. As water collects in the collection chamber, it generates pressure which causes it to flow out of orifices in the mid plate 17. A first set of orifices 26 form a smaller diameter ring than a second set of orifices 32 which are axially spaced out from the center of the mid plate 17. A separation wall 42 extends from the front side 40 of the mid plate 17 separating the first set of orifices 26 from the second set of orifices 32.

The separation wall 42 allows the water that passes through the first set of orifices 26 to be kept separately from the water that passes through the second set of orifices 32. The support flange 28 abuts the front plate 11 to maintain the separation of the respective water from the first set of orifices 26 and the second set of orifices 32 thereby forming a first swirl chamber 22 and a second swirl chamber 24.

Water that enters the first swirl chamber 22 from the first set of orifices 26, and water that enters the second swirl chamber 24 from the second set of orifices 32, may be compelled to store kinetic energy. The first swirl chamber 22 may store the water, and preserve its kinetic energy separately from water in the second swirl chamber 24, and vice versa. The kinetic energy may be generated in the form of water momentum by separately swirling the water around the first swirl chamber 22 and the second swirl chamber 24. In order to swirl the water, the first set of orifices 26 and the second set of orifices 32 may be formed through the thickness of the mid plate 17 at an angle other than normal to a surface of the mid plate 17.

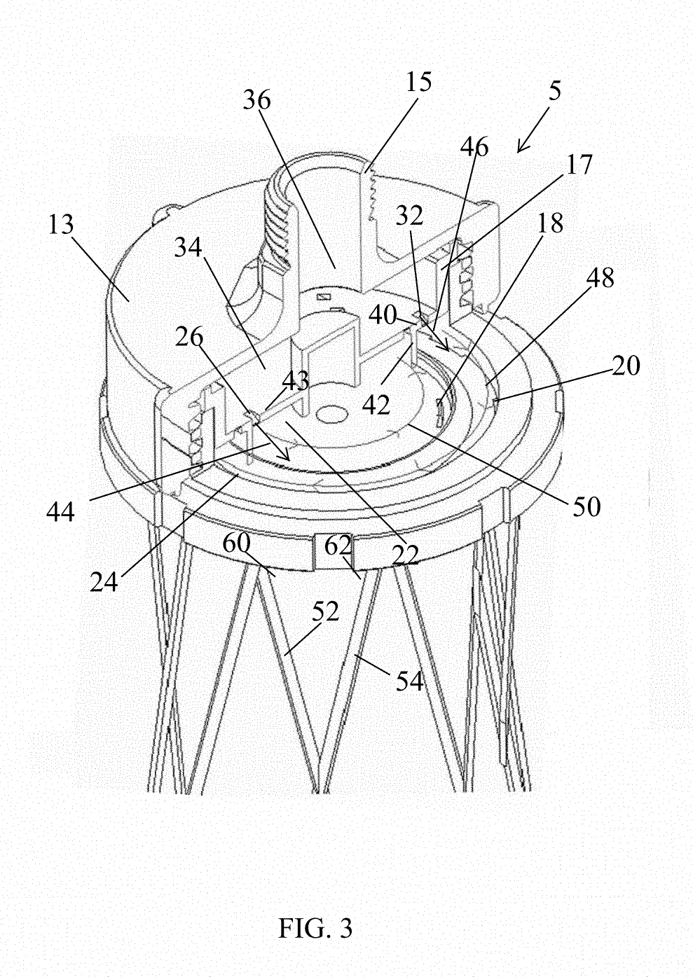

For example, looking to FIG. 3, a representation of the showerhead engine 5 is shown. The back plate 13 allows water to collect in the collection chamber 34 prior to passing through the mid plate 17. As shown in the representation, the first set of orifices 26 are formed at an angle 43 with respect to the surface of the mid plate 17. Similarly, the second set of orifices 32 are formed through the mid plate 17 at an angle 40 which is different than angle 43. The angle 43 of the first set of orifices 26 thereby produces a water jet 44 that is angled. The angle 40 of the second set of orifices 32 also produces a water jet 46 that is also angled, but note the direction of each respective water jet. The different angles produce water jets in different directions.

The first swirl chamber 22, best shown in FIG. 2, causes water to swirl within the separation wall 42 and a center wall 49. Each of the respective walls 42, 49 includes a curvature, which compels the water jet 44 to run alongside of. The result is a swirling motion 48 (in this case, generally circular) which is influenced by and follows a rotational direction consistent with the angled direction of the water jet 44.

Similarly, the second swirl chamber 24, best shown in FIG. 2, causes water to swirl within the separation wall 42 and the front plate wall 51. Each respective wall 42, 51 also includes a curvature, which compels the water jet 46 to run alongside of. The result is a swirling motion 50 (in this case, also generally circular) which is influenced by and follows a rotational direction consistent with the angled direction of the water jet 46.

During operation, the water within the first swirl chamber 22 and the second swirl chamber 24 continues to swirl, building up momentum and an angular velocity. The respective angular velocities are shown in the form of the swirling motions 48, 50. As the pressure builds, the water exits through a first set of holes 18 and a second set of holes 24. The first set of holes 18 expel water within the first swirling chamber 22 in the form of a water jet 52 at an angle 60. The second set of holes 20 expel water within the second swirling chamber 24 in the form of a water jet 54 at a different angle 62. The angles of water jets 52 and 54 are generated as a result of the swirling motion within the respective swirl chambers and not, for example, by an angled shape of the first and second set of holes 18, 20.

Preferably, the first set of holes 18 and the second set of holes 20 are in the form of elongated slots as shown in FIG. 2. The slots are preferably extended along the arc of the swirling motion, which allows the exiting water to maintain angular velocity as it passes through the face surface 30 of the front plate 11.

Although the present disclosure has been described with reference to particular means, materials and embodiments, from the foregoing description, one skilled in the art can easily ascertain the essential characteristics of the present disclosure and various changes and modifications may be made to adapt the various uses and characteristics without departing from the spirit and scope of the present invention as set forth in the following claims.

I claim:

1. A showerhead engine comprising:
a back plate with an opening in fluid communication with a supply of water;
a mid plate spaced apart from the back plate forming a collection chamber between the back plate and the mid plate;
a first set of orifices in the mid plate at a first diameter;
a second set of orifices in the mid plate at a second diameter greater than the first diameter;
a front plate spaced apart from the mid plate, the front plate and mid plate cooperatively forming a first swirl chamber and a second swirl chamber between the front plate and the mid plate;
a separation wall extending between the front plate and the mid plate, the separation wall separating the first swirl chamber from the second swirl chamber;
a first set of holes in the front plate in fluid communication with the first swirl chamber; and
a second set of holes in the front plate in fluid communication with the second swirl chamber.

2. The showerhead engine according to claim 1, wherein the first set of orifices in the mid plate are formed at an angle other than normal to a front side of the mid plate such that as water passes through the first set of orifices it exits the front side and enters the first swirl chamber with an angular velocity thus generating a swirling motion of the water within the first swirl chamber.

3. The showerhead engine according to claim 1, wherein the second set of orifices in the mid plate are formed at an angle other than normal to a front side of the mid plate such that as water passes through the second set of orifices it exits the front side and enters the second swirl chamber with an angular velocity thus generating a swirling motion of the water within the second swirl chamber.

4. The showerhead engine according to claim 1, wherein the first set of orifices in the mid plate and the second set of orifices in the mid plate are each respectively formed at different angles other than normal to a front side of the mid plate such that as water passes through the first and second set of orifices it exits the front side and enters the first and second swirl chambers with an angular velocity thus generating a swirling motion of the water within the first and second swirl chambers.

5. The showerhead engine according to claim 4, wherein the angular velocity of the water in first swirl chamber is clockwise and the angular velocity of the water in the second swirl chamber is counter clockwise.

6. The showerhead engine according to claim 1, wherein water exits the first and second set of holes in the front plate at an angle other than normal to a face surface of the front plate.

7. The showerhead engine according to claim 6, wherein the first and second set of holes in the front plate are elongated slots that are normal to the face surface.

8. A showerhead engine comprising:
a back plate with an opening configured for fluid communication with a supply of water;
a mid plate, with a plurality of orifices through parallel surfaces, secured at least partially within a recess formed into the back plate;
a support flange extending around a perimeter of the mid plat configured to engage the recess in the back plate such that the supply of water flows through the plurality of orifices in the mid plate;
wherein the first set of orifices are formed through the mid plate at an angle less than normal to the parallel surfaces of the mid plate and wherein the second set of orifices are formed through the mid plate at an angle greater than normal to the parallel surfaces of the mid plate;
a front plate with a face surface spaced apart from the mid plate forming a first swirl chamber for water exiting the first set of orifices and a second swirl chamber for water exiting the second set of orifices; and
a first set of holes in the front plate in fluid communication with the first set of orifices configured to each deliver a stream of water at an angle less than normal to the face surface of the front plate and;
a second set of holes in the front plate in fluid communication with the second set of orifices configured to each deliver a stream of water at an angle greater than normal to the face surface of the front plate.

9. The showerhead engine according to claim 8, wherein the first set of orifices in the mid plate and the second set of orifices in the mid plate are each respectively formed at different angles other than normal to a front side of the mid plate such that as water passes through the first and second set of orifices it exits the front side and enters the first and second swirl chambers with an angular velocity thus generating a swirling motion of the water within the first and second swirl chambers.

10. The showerhead engine according to claim 9, wherein the angular velocity of the water in first swirl chamber is clockwise and the angular velocity of the water in the second swirl chamber is counter clockwise.

11. The showerhead engine according to claim 8, wherein water exits the first and second set of holes in the front plate at an angle other than normal to a front surface of the face surface of the front plate.

12. The showerhead engine according to claim 8, wherein the plurality of orifices includes a first set of orifices in the mid plate each at a distance from a center of the mid plate and a second set of orifices in the mid plate each at a second distance from the center of the mid plate, wherein the second distance is greater than the first distance.

13. The showerhead engine according to claim 8, further comprising a separation wall extending from the mid plate between the first set of orifices and the second set of orifices, and wherein the water within the first swirl chamber is kept separate from the water in the second swirl chamber by the separation wall.

14. The showerhead engine according to claim 13, wherein the water within the first swirl chamber flows clockwise thus exiting the first set of holes at a first angle and wherein the water within the second swirl chamber flows counter clockwise thus exiting the second set of holes at an second angle different than the first angle.

15. A swirl chamber for a showerhead engine comprising:
a mid plate with parallel front and back side;
a plurality of orifices through the mid plate formed at an angle other than normal to the front and back side of the mid plate;
a support flange extending from the front side of the mid plate separating a portion of the plurality of orifices;
a back plate engaging the back side of the mid plate with an opening configured for fluid communication with a supply of water;
a front plate with a face surface spaced apart from the mid plate forming a first and a second swirl chamber for water exiting the plurality of orifices in the mid plate;
a plurality of holes in communication with the first and second swirl chamber configured to deliver the water from the first and second swirl chambers at varying angles other than normal to the face surface.

16. The swirl chamber according to claim 15, wherein the plurality of orifices comprises a first set of orifices in the mid plate and a second set of orifices in the mid plate, each respectively formed at different angles other than normal to a front side of the mid plate such that as water passes through the first and second set of orifices it exits the front side and enters the first and second swirl chambers with an angular velocity thus generating a swirling motion of the water within the first and second swirl chambers.

17. The swirl chamber according to claim 16, further comprising a separation wall extending from the mid plate between the first set of orifices and the second set of orifices, and wherein the water within the first swirl chamber is kept separate from the water in the second swirl chamber by the separation wall.

18. The swirl chamber according to claim 16, wherein the water exiting the plurality of holes in the front plate from the first and second swirl chambers exit at multiple angles.

19. The swirl chamber according to claim 16, wherein the water in the first and second swirl chambers moves with an angular velocity such that it exits the plurality of holes in the front plate at an angle.

20. The swirl chamber according to claim 16, wherein the plurality of holes in the front plate is elongated slots.
